(19) United States
(12) Patent Application Publication
(10) Pub. No.: US 2026/0119823 A1
(43) Pub. Date: Apr. 30, 2026

(54) SPEECH TRANSLATION METHOD, ELECTRONIC DEVICE, STORAGE MEDIUM, AND PROGRAM PRODUCT

(71) Applicants: Beijing Zitiao Network Technology Co., Ltd., Beijing (CN); Lemon Inc., Grand Cayman (KY)

(72) Inventors: Tao HAN, Singapore (SG); Yisheng LIN, Singapore (SG); Van Tung PHAM, Sydney (AU); Jun ZHANG, Beijing (CN); Lu LU, Los Angeles, CA (US); Yuxuan WANG, Los Angeles, CA (US)

(21) Appl. No.: 19/373,292

(22) Filed: Oct. 29, 2025

(30) Foreign Application Priority Data
Oct. 29, 2024 (CN) 202411523967.8

(51) Int. Cl. G06F 40/58; G10L 15/02; G10L 15/06; G10L 15/183

(52) U.S. Cl. CPC G06F 40/58; G10L 15/02; G10L 15/063; G10L 15/183

(57) ABSTRACT

Embodiments of the present disclosure provide a speech translation method, an electronic device, a storage medium, and a program product. The method includes: inputting an audio clip in a source language into an audio feature extractor in a speech translation model to extract, via the audio feature extractor, an audio feature corresponding to the audio clip; and inputting the audio feature into a language model in the speech translation model to obtain, via the language model, a translated text in a target language that corresponds to the audio clip, where a first scaling factor is used for the language model during fine-tuning, a second scaling factor is used for the language model during determination of the translated text, and the second scaling factor is less than the first scaling factor.

### CROSS-REFERENCE TO RELATED APPLICATION(S)

This application claims priority to Chinese Application No. 202411523967.8 filed Oct. 29, 2024, the disclosure of which is incorporated herein by reference in its entity.

### FIELD

The present disclosure generally relates to the field of computers, and more particularly to a speech translation method, an electronic device, a storage medium, and a computer program product.

### BACKGROUND

With the rapid development of an artificial intelligence (AI) technology, the AI technology has become widely and universally applicable in various fields. As an important branch of the AI technology, natural language processing (NLP) enables processing and analysis of a text based on the AI technology, so that a computer can understand and process a human language, thereby supporting interaction between the computer and the human language. In addition, NLP is widely used in various scenarios.

### SUMMARY

According to example embodiments of the present disclosure, a speech translation method, a method for training a speech translation model, an electronic device, and a computer storage medium are provided.

According to a first aspect of the present disclosure, a speech translation method is provided, including: inputting an audio clip in a source language into an audio feature extractor in a speech translation model to extract, via the audio feature extractor, an audio feature corresponding to the audio clip; and inputting the audio feature into a language model in the speech translation model to obtain, via the language model, a translated text in a target language that corresponds to the audio clip, where a first scaling factor is used for the language model during fine-tuning, a second scaling factor is used for the language model during determination of the translated text, and the second scaling factor is less than the first scaling factor.

According to a second aspect of the present disclosure, a method for training a speech translation model is provided. The speech translation model includes an audio feature extractor and a language model. The method includes: adjusting a parameter of the audio feature extractor by using an alignment training dataset, to obtain the trained speech translation model, where the alignment training dataset includes a plurality of training data pairs, each training data pair includes a training audio clip in a source language and a continuation text in the source language that corresponds to the training audio clip, and the continuation text is generated by the language model for the training audio clip; and fine-tuning the speech translation model by using a first scaling factor to obtain a fine-tuned speech translation model, where a second scaling factor is used for the fine-tuned speech translation model during inference, and the second scaling factor is less than the first scaling factor.

According to a third aspect of the present disclosure, an electronic device is provided, including: at least one processing unit; and at least one memory coupled to the at least one processing unit and storing instructions executable by the at least one processing unit, where the instructions, when executed by the at least one processing unit, cause the electronic device to perform the method as described in the first aspect or the second aspect of the present disclosure.

According to a fourth aspect of the present disclosure, a computer-readable storage medium having machine-executable instructions stored thereon is provided, where the machine-executable instructions, when executed by a device, cause the device to perform the method as described in the first aspect or the second aspect of the present disclosure.

According to a fifth aspect of the present disclosure, a computer program product including computer-executable instructions is provided, where the computer-executable instructions, when executed by a processor, cause the method as described in the first aspect or the second aspect of the present disclosure to be implemented.

The section Summary is provided to describe a series of concepts in a simplified form, which will be further described in the detailed description below. The section Summary is neither intended to identify critical or essential features of the present disclosure, nor is it intended to limit the scope of the present disclosure. Other features of the present disclosure will be readily understood from the following description.

### BRIEF DESCRIPTION OF THE DRAWINGS

The above-mentioned and other features, advantages, and aspects of embodiments of the present disclosure become more apparent with reference to the following detailed description and in conjunction with the accompanying drawings. In the accompanying drawings, the same or similar reference numerals denote the same or similar elements.

FIG. 1 illustrates a schematic diagram of an example system in which embodiments of the present disclosure can be implemented;

FIG. 2 illustrates a flowchart of a speech translation method according to an embodiment of the present disclosure;

FIG. 3 illustrates a schematic block diagram of a speech translation model according to an embodiment of the present disclosure;

FIG. 4 illustrates a flowchart of a training process for training a speech translation model according to an embodiment of the present disclosure;

FIG. 5 illustrates a flowchart of a method for training a speech translation model according to an embodiment of the present disclosure;

FIG. 6 illustrates a schematic block diagram of an example apparatus according to some embodiments of the present disclosure;

FIG. 7 illustrates a schematic block diagram of an example apparatus according to some embodiments of the present disclosure; and

FIG. 8 illustrates a block diagram of an example device that may be used to implement an embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for example purposes, and are not intended to limit the scope of protection of the present disclosure.

Natural language processing (NLP) is widely used in various scenarios. Integration of a speech encoder into a language model (e.g., a large language model (LLM)) has shown significant progress of NLP in the speech processing field. Such integration may convert a speech signal into a format compatible with a text input processed by the language model, so that speech data may be integrated into an architecture of the language model to allow the language model to process speech-based tasks, for example, tasks such as automatic speech recognition (ASR), automatic speech translation (AST), or speech question and answer, etc.

Integrating the speech encoder with the language model to perform an automatic speech translation (AST) task has been widely studied. In the prior art, a model is usually trained by using a task-specific training method, to execute the AST task. During task-specific training, the model is usually trained by using AST training data. The AST training data includes pairs of training sample data, each pair of training sample data includes audio data in a source language and a translated text in a target language that corresponds to the audio data. The trained model may translate audio in the source language into translated text in the target language.

Current research has made some progress and achievements in the AST task, but still has some drawbacks. For example, since the task-specific training method is used during the training, the model performs well during the inference with respect to translation tasks in the source language and the target language for which training is performed. However, the model does not perform satisfactorily with respect to a target language that is not used during the training. In other words, with respect to a target language that is “unveiling” during the training, the model trained by using the task-specific training method has a low generalization capability for an unveiling task.

Therefore, there is a need for a speech translation model having an improved model generalization capability. The model can efficiently process speech data and can be better generalized to a target language that has not been used during the training. In other words, the model has an improved model performance and capability.

In view of this, an embodiment of the present disclosure provides a speech translation method. The method includes: inputting an audio clip in a source language into an audio feature extractor in a speech translation model to extract, via the audio feature extractor, an audio feature corresponding to the audio clip; and inputting the audio feature into a language model in the speech translation model to obtain, via the language model, a translated text in a target language that corresponds to the audio clip, where a first scaling factor is used for the language model during fine-tuning, a second scaling factor is used for the language model during determination of the translated text, and the second scaling factor is less than the first scaling factor.

In addition, an embodiment of the present disclosure further provides a method for training a speech translation model. The speech translation model includes an audio feature extractor and a language model. The method includes: adjusting a parameter of the audio feature extractor by using an alignment training dataset, to obtain the trained speech translation model, where the alignment training dataset includes a plurality of training data pairs, each training data pair includes a training audio clip in a source language and a continuation text in the source language that corresponds to the training audio clip, and the continuation text is generated by the language model for the training audio clip; and fine-tuning the speech translation model by using a first scaling factor to obtain a fine-tuned speech translation model, where a second scaling factor is used for the fine-tuned speech translation model during inference, and the second scaling factor is less than the first scaling factor.

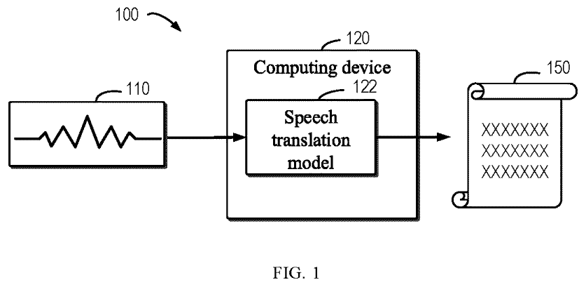

Embodiments of the present disclosure are further described in detail below with reference to the accompanying drawings. FIG. 1 illustrates a schematic diagram of an example environment 100 in which embodiments of the present disclosure can be implemented. The example environment 100 includes a computing device 120, and the computing device 120 may include a speech translation model 122. The speech translation model 122 may be trained to implement an automatic speech translation (AST) task. The automatic speech translation task may refer to a task translating audio 110 in a source language into a text 150 in a target language. In some embodiments, the speech translation model 122 may be arranged separately from the computing device 120. For example, the speech translation model 122 may be arranged on another computing device. When using the speech translation model 122, the computing device 120 may invoke the speech translation model 122 to implement an automatic speech translation task.

In addition, the speech translation model 122 may be trained by the computing device 120, and the trained speech translation model 122 may be integrated into the computing device 120, or be arranged separately from the computing device 120. The speech translation model 122 may alternatively be trained by a different computing device other than the computing device 120. The trained speech translation model may be integrated into the different computing device, or may be arranged separately from the different computing device. The present disclosure imposes no limitation on the computing device used for training the speech translation model 122 or the computing device on which the trained speech translation model 122 is installed.

The computing device 120 includes but is not limited to a personal computer, a server computer, a handheld or laptop device, a mobile device (for example, a mobile phone, a personal digital assistant (PDA), or a media player, etc.), a multiprocessor system, a consumer electronics product, a wearable electronic device, a smart home device, a minicomputer, a mainframe computer, an edge computing device, or a distributed computing environment including any one of the above-mentioned systems or devices.

In some embodiments, the computing device 120 may perform a method for speech translation (e.g., automatic speech translation (AST)). In some embodiments, the computing device 120 may input an audio clip in a source language into an audio feature extractor in a speech translation model 122 to extract, via the audio feature extractor, an audio feature corresponding to the audio clip. The computing device 120 may input the audio feature into a language model in the speech translation model 122 to obtain, via the language model, a translated text in a target language that corresponds to the audio clip. In some embodiments, a first scaling factor is used for the language model during fine-tuning, and a second scaling factor is used for the language model during determination of the translated text. In some embodiments, the second scaling factor is less than the first scaling factor.

In some embodiments, the computing device 120 may be configured to train the speech translation model 122. The speech translation model 122 may include an audio feature extractor and a language model. The computing device 120 may adjust a parameter of the audio feature extractor by using an alignment training dataset to obtain the trained speech translation model. In some embodiments, the alignment training dataset includes a plurality of training data pairs, each training data pair includes a training audio clip in a source language and a continuation text in the source language that corresponds to the training audio clip. In some embodiments, the continuation text is generated by the language model for the training audio clip. The computing device 120 may further fine-tune the speech translation model by using a first scaling factor to obtain the fine-tuned speech translation model. In some embodiments, a second scaling factor is used for the fine-tuned speech translation model during inference, and the second scaling factor is less than the first scaling factor.

By using the method for training a speech translation model according to this embodiment of the present disclosure, a speech translation model having an improved model generalization capability may be obtained. During inference by using the model, the model can efficiently process speech data and can be better generalized to a target language that has not been used during the training. In other words, the model has an improved model performance and capability, so that the model can also well process a translation task in an unveiling target language.

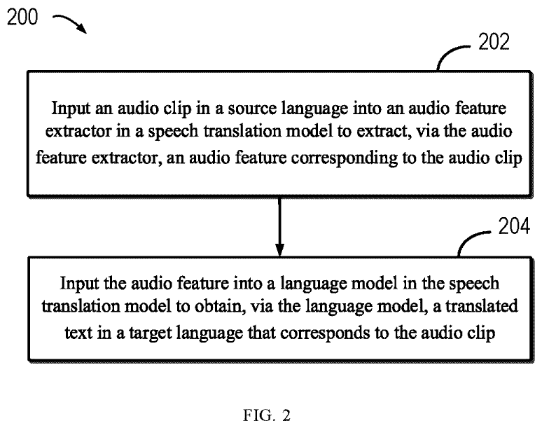

A block diagram of the example environment 100 in which the embodiments of the present disclosure can be implemented is described above with reference to FIG. 1. A flowchart of a speech translation method 200 according to an embodiment of the present disclosure is described below with reference to FIG. 2. FIG. 2 is a flowchart of a speech translation method according to an embodiment of the present disclosure. The method 200 may be performed in the computing device 120 in FIG. 1 or in any proper computing device. It should be understood that a number in the flowchart of the method 200 does not indicate a sequence in which the steps are performed, and some or all of the steps may be performed in parallel, or an execution sequence may be interchanged, which is not limited in the present disclosure. In addition, the method 200 in FIG. 2 may further include additional steps not shown and/or shown steps may be omitted, and the scope of the present disclosure is not limited in this respect.

As shown in FIG. 2, in block 202, the computing device 120 may input an audio clip in a source language into an audio feature extractor in a speech translation model 122 to extract, via the audio feature extractor, an audio feature corresponding to the audio clip.

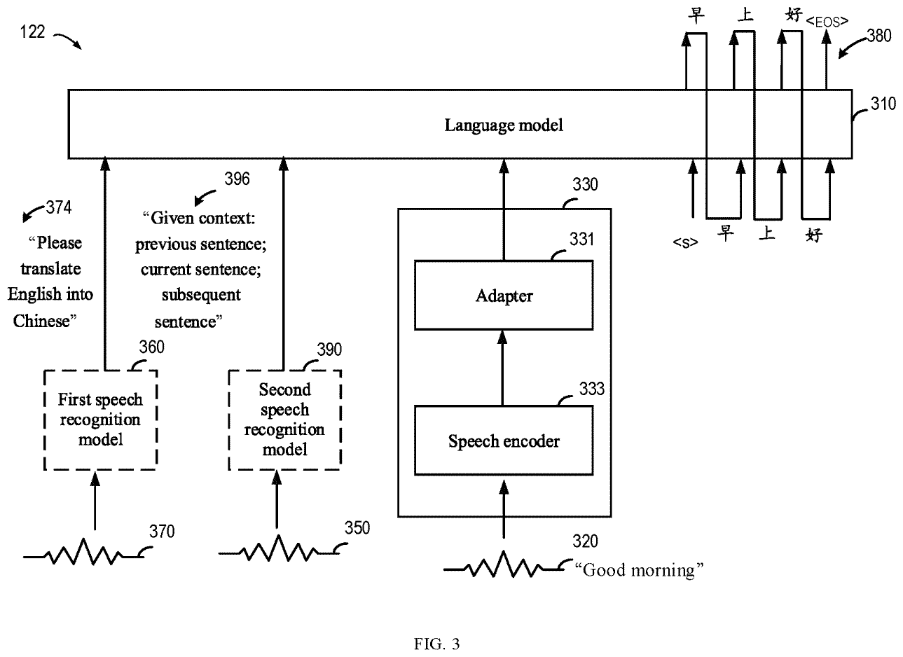

The speech translation model 122 according to this embodiment of the present disclosure is described below with reference to FIG. 3. FIG. 3 is a schematic block diagram of a speech translation model 122 according to an embodiment of the present disclosure. As shown in FIG. 3, the speech translation model 122 includes a language model (e.g., a large language model) 310 and an audio feature extractor 330. The language model 310 is a model that may execute a text processing task (e.g., a text generation task or a text translation task). The audio feature extractor 330 includes an adapter 331 and a speech encoder 333. The audio feature extractor 330 is configured to perform audio feature extraction on a received speech signal such as an audio clip 320, to obtain an audio feature corresponding to the speech signal. The audio feature may be input into the language model 310 for subsequent text processing, such as execution of a translation task, etc.

In some embodiments, the speech translation model 122 may further include a first speech recognition model 360) and a second speech recognition model 390. In some embodiments, the first speech recognition model 360) may recognize a received speech instruction 370 as an instruction text corresponding to the speech instruction 370, for example, as illustrated in 374 in FIG. 3, “Please translate English into Chinese.” The instruction text 374 is further input into the language model 310. The instruction text 374 may be processed by a first text embedding model (not shown; the first text embedding model may be placed inside or outside the language model 310, which is not limited in the present disclosure) to extract a text feature in the instruction text 374. The extracted text feature may be determined as a first text feature corresponding to an instruction, and continues to be processed by the language model 310. In some embodiments, during inference performed by the language model 310, the first text feature corresponding to the instruction 370 may be used as auxiliary information in a process in which the language model 310) executes an automatic speech translation task, so as to assist the language model 310 in executing the translation task. For example, the instruction 370) may indicate a task (e.g., a translation task) that needs to be executed by the language model 310, and the instruction 370) may indicate a source language (e.g., English) and a target language (e.g., Chinese) of the translation task.

Furthermore, when the speech translation model 122 does not include the first speech recognition model 360), the speech translation model 122 may receive an instruction in a text form, for example, “Please translate English into Chinese” in a text form, and input the text instruction into the first text embedding model, so that the first text embedding model extracts a text feature of the instruction in the text form. The extracted text feature may be determined as a first text feature T1, and continues to be processed by the language model 310.

In some embodiments, the second speech recognition model 390 in the speech translation model 122 may receive an audio input. The audio input may be speech information that needs to be translated, for example, an audio clip. The second speech recognition model 390 may segment the audio input into a plurality of audio segments. The second speech recognition model 390 may further perform speech recognition on the audio input and obtain a text corresponding to each audio segment (e.g., a text in the form of sentences, where each sentence corresponds to each audio segment). For example, the second speech recognition model 390) may segment the audio input into a plurality of audio segments A₁, A₂, . . . , and Aₜ, and by performing speech recognition, the second speech recognition model 390 may obtain texts S₁, S₂, . . . , and Sₜ corresponding to the audio segments, respectively. In other words, the second speech recognition model may process the audio input to obtain an output text in the source language that corresponds to the audio input. The audio input includes an audio clip to be translated (for example, an audio clip 320). In some embodiments, the computing device 120 may sequentially input, into the audio feature extractor 330, the audio clips obtained through segmentation, so that the audio feature extractor 330) performs feature extraction on the input audio clips, thereby further implementing translation processing of the audio clips.

In some embodiments, an output of the second speech recognition model 390) may be context information 396 having a specified format. In some embodiments, the context information 396 is in the source language, that is, in the same language as the audio input. For example, the specified format may be: {given context: previous sentence; current sentence; subsequent sentence}. In some embodiments, in the format of the output, the text of the “current sentence” is the corresponding text of the audio clip to be currently translated (e.g., the audio clip 320 in FIG. 3); the “previous sentence” is the corresponding text of the previous audio clip adjacent to the audio clip to be currently translated; and the “subsequent sentence” is the corresponding text of the subsequent audio clip adjacent to the audio clip to be currently translated. For example, with respect to an audio input “It is 8 o'clock. Good morning. It is time to go to school,” the audio clip 320 to be currently translated may be “Good morning” in an audio form, the previous audio clip of the audio clip 320 is “It is 8 o'clock” in an audio form, and the subsequent audio clip is “It is time to go to school” in an audio form. After the processing of the audio input, the output of the second speech recognition model 390 may be: {given context: It is 8 o'clock; Good morning; It is time to go to school}.

In some embodiments, the context information 396 in the specified format may be provided to the language model 310. The context information provided to the language model 310 corresponds to the audio clip 320 (i.e., the audio clip to be currently translated) input into the audio feature extractor 330. In other words, in the context information, the current sentence corresponds to the audio clip 320. For example, when the audio clip is “Good morning” in an audio form, the “current sentence” in the context information 396 is “Good morning” in a text form.

In some embodiments, the context information 396 may be processed by a second text embedding model (not shown; the second text embedding model may be placed inside or outside the language model 310, which is not limited in the present disclosure) to extract a text feature in the context information 396. The extracted text feature may be determined as a second text feature T2 corresponding to context information, and continues to be processed by the language model 310. Given context information in the specified format may provide auxiliary information for the audio clip 320, thereby making translation for the audio clip 320 more accurate and precise.

In some embodiments, based on the segmentation and recognition of the audio input by the second speech recognition model 390, the computing device 120 may receive the audio clip 320 in the source language (for example, use the audio clip 320 as the audio clip to be currently translated), for example, “Good morning” in an audio form. The computing device 120 may input the received audio clip 320 into the audio feature extractor 330 in the speech translation model 122 to extract, via the audio feature extractor 330, an audio feature F₁ corresponding to the audio clip 320. For example, the audio feature F₁ corresponding to the audio clip 320 may be obtained at the output of the audio feature extractor 330.

Referring back to FIG. 2, in block 204, the computing device 120 may input the audio feature F₁ into a language model 310 in the speech translation model 122 to obtain, via the language model 310, a translated text Tₒᵤₜ in a target language that corresponds to the audio clip 320. In some embodiments, a first scaling factor α₁ may be used for the language model 310 during fine-tuning, a second scaling factor α₂ may be used for the language model 310 during determination of the translated text, and the second scaling factor α₂ is less than the first scaling factor α₁.

In some embodiments, the speech translation model 122 needs to be trained before the speech translation model 122 may execute an automatic speech translation task. In the initial speech translation model 122, the language model 310 may be a pre-trained model and may be used to execute a text processing task (e.g., a text generation task). Various training methods known in the art may be used to perform a pre-training operation on the language model 310. This is not limited in the present disclosure.

In some embodiments, with respect to the initial speech translation model 122, a parameter of the language model 310 may be fixed, training in a first phase and training in a second phase are performed on the audio feature extractor 330, and during the training in the two phases, the parameter of the audio feature extractor 330 is adjusted to obtain the trained speech translation model 122. The training processes in the two phases are described in detail below.

After the training in the two phases performed on the speech translation model 122 is completed, a fine-tuning process may be performed on the trained speech translation model 122. The fine-tuning process is performed for the language model 310. During the fine-tuning, the parameter of the audio feature extractor 330 may be fixed, that is, the parameter of the audio feature extractor 330 remains unchanged. In addition, during the fine-tuning, with respect to the language model 310, a pre-trained parameter W₀ in the language model 310 is fixed, and a bypass structure is added to the language model 310. A parameter corresponding to the bypass structure is W₁. The parameter W₁ is used as a parameter to be adjusted for the language model 310. In other words, the parameter W₁ to be adjusted is a parameter newly added to the language model 310 during the fine-tuning. During the fine-tuning, the first scaling factor α₁ is used to scale the parameter W₁ to be adjusted in the language model 310. Therefore, during the fine-tuning, the parameters of the language model 310 are the fixed parameter W₀ and the parameter W₁ to be adjusted. The training input being x is used as an example. The output y of the language model 310 is shown in Equation 1 below:

$$y = {W}_{0} x + {α}_{1} {W}_{1} x \qquad ( Equation 1 )$$

A training device may adjust the parameter W₁ to be adjusted, by using a predetermined loss function based on the training input and the training output of the language model 310. The training device may adjust the parameter W₁ to be adjusted, by using various known or future developed methods, so as to obtain the fine-tuned language model 310.

In some embodiments, the training data used during the fine-tuning includes fine-tuning training data. The fine-tuning training data may include a plurality of training data pairs, and each training data pair includes a fine-tuned audio clip in a source language and a training text in a sample language that corresponds to the fine-tuned audio clip. In some embodiments, with respect to an AST task, the fine-tuning training data includes a fine-tuned audio clip in a source language and a translated text in a sample language that corresponds to the fine-tuned audio clip. The fine-tuned language model 310 may be obtained by scaling the newly added parameter to be adjusted in the language model 310 by using the first scaling factor α₁, and adjusting the parameter of the language model 310 based on the fine-tuning training data. In this way, the fine-tuned speech translation model 122 may be obtained. The fine-tuned speech translation model 122 may be used to execute an AST task.

During execution of the AST task, the adjusted parameter in the language model 310 is scaled by using the second scaling factor α₂. Correspondingly, when executing the AST task, the speech translation model 122 translates the received audio feature corresponding to the input audio clip 320 by using the parameter that is scaled by the second scaling factor α₂, so as to obtain the translated text Tₒᵤₜ in the target language. In some embodiments, the adjusted parameter corresponds to the newly added parameter to be adjusted for the language model 310 during the fine-tuning. In other words, after the adjustment of the parameter to be adjusted during the fine-tuning, a corresponding adjusted parameter in the language model 310 may be obtained.

In some embodiments, during the execution of the AST task by the speech translation model 122, the target language used by the speech translation model may be different from the sample language in the fine-tuning training data used during the fine-tuning. For example, the sample language of the training data used during the fine-tuning may be Spanish. However, during the execution of the AST task, the target language used by the speech translation model 122 may be a target language different from the sample language, such as Japanese, French, or German, etc.

It may be understood that the speech translation model 122 according to this embodiment of the present disclosure is a speech translation model having an improved model generalization capability. During inference by using the model, the model can efficiently process speech data and can be better generalized to a target language that has not been used during the training. In other words, the model has an improved model performance and capability, so that the model can also well execute a translation task in an unveiling target language.

In some embodiments, the second scaling factor α₂ used during determination of the translated text is less than the first scaling factor α₁ used during the fine-tuning. That is, α₂<α₁. In some embodiments, the second scaling factor is 0.5 times the first scaling factor. Advantageously, by reducing the scaling factor during inference, the generalization capability of the speech translation model 122 for the target language that is not used during training may be improved, thereby improving the generalization capability of the speech translation model 122.

FIG. 3 is still used as an example for description. As shown in FIG. 3, the computing device 120 may input the audio feature F1 of the audio clip 320 into the language model 310. The language model 310 may combine the audio feature F1 with the first text feature T1 extracted based on the instruction and the second text feature T2 extracted based on the context information 396, as described above, and obtain the translated text of the audio clip 320 based on the combined feature.

The example in FIG. 3 is used for description. With respect to the instruction of “Please translate English into Chinese,” the speech translation model 122 may translate an audio input 350 in the source language of English into a translated text in the target language of Chinese. For example, the audio input is “It is 8 o'clock. Good morning. It is time to go to school” in an audio form. With respect to the current audio clip 320 “Good morning,” the speech translation model 122 may receive corresponding context information “{given context: It is 8 o'clock; Good morning; It is time to go to school}”. The context information is in a text form and in the source language. The computing device 120 may input the audio clip 320 into the audio feature extractor 330 to obtain the audio feature F1 of the audio clip 320. The language model 310 may combine the audio feature F1 with the first text feature T1 extracted based on the instruction and the second text feature T2 extracted based on the context information 396, and obtain the translated text of the audio clip 320 based on the combined feature. As shown in FIG. 3, with respect to the audio clip 320 “Good morning,” the language model 310 may output the translated text “ [symbol] ” for the audio clip 320 “Good morning.”

In some embodiments, the computing device 120 may sequentially input, into the audio feature extractor 330, audio clips obtained through segmentation in the audio input, and correspondingly input, into the language model 310, context information associated with the audio clips that are input into the audio feature extractor 330, so that the audio feature extractor 330 and the language model 310 perform translation processing in the above-mentioned manner and obtain a corresponding translated text. In some embodiments, the current sentence in the context information associated with audio clip A is a text corresponding to the audio clip A.

The computing device 120 may combine the obtained translated texts to obtain the translated text for the audio input. For example, for the audio input of “It is 8 o'clock. Good morning. It is time to go to school,” the computing device may obtain translated texts “8 [symbol] ”, “ [symbol] ”, and “ [symbol] ” for the audio clips “It is 8 o'clock,” “Good morning,” and “It is time to go to school,” respectively. The computing device 120 may combine the obtained translated texts to obtain the translated text “8 [symbol] , [symbol] [symbol] ” for the audio input. It may be understood that the example in FIG. 3 is merely exemplary for illustrative purposes. Those skilled in the art may translate the audio input in different source languages for different target languages as required.

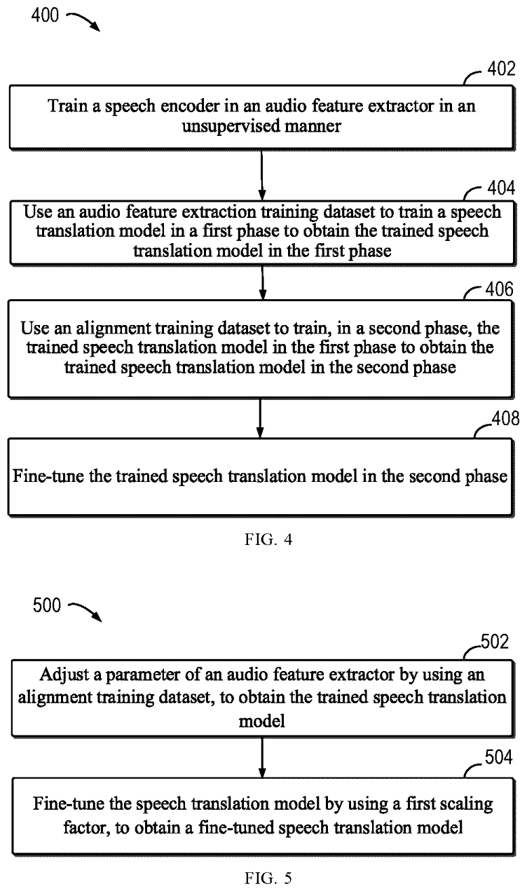

A schematic diagram of the training process for training a speech translation model is described below with reference to the accompanying drawings. FIG. 4 is a flowchart of a training process for training a speech translation model according to an embodiment of the present disclosure. The method 400 may be performed in the computing device 120 in FIG. 1 or in any proper computing device. For ease of illustration, in the following description, a device performing a training process 400 is referred to as a “training device.” It should be understood that, the method 400 in FIG. 4 may further include additional steps not shown and/or shown steps may be omitted, and the scope of the present disclosure is not limited in this respect.

In block 402, the training device may use a training audio dataset to train a speech encoder 333 in an initial speech translation model 122, for example, may adjust a parameter in the speech encoder 333. In some embodiments, the initial speech translation model 122 may include an untrained audio feature extractor 330 and a pre-trained language model 310. The training audio dataset may include a plurality of training audio clips, and the training device may perform unsupervised training on the speech encoder 333. In some embodiments, after training of all training audio clips in the training audio dataset is completed, the training device may determine that the training of the speech encoder 333 is completed.

In block 404, the training device may use an audio feature extraction training dataset to train the speech translation model 122 in a first phase. The audio feature extractor 330 trained in the first phase may include an adapter 331 and a speech encoder 333 trained in block 402.

In some embodiments, in the first phase, the training device may fix a parameter in the language model 310, and adjust a parameter of the adapter 331 and a parameter of the speech encoder 333 in the audio feature extractor 330. In some embodiments, the training data used by the training device in the first phase includes the audio feature extraction training dataset. The training dataset includes a plurality of training data pairs Pₜᵢ (i is a positive integer; 1≤i≤N; N is the number of training data pairs in the audio feature extraction training dataset), and each training data pair Pₜᵢ includes a training audio clip Dₜᵢ in the source language and a training text Tₜᵢ in the source language that corresponds to the training audio clip.

For example, the source language may be English, the training audio clip Dₜ₁ may be “how are you” in an audio form, and the training text Tₜ₁ in the source language that corresponds to the training audio clip may be “how are you” in a text form. The audio feature extraction training dataset may be represented as {Pₜ₁(Dₜ₁, Tₜ₁); Pₜ₂(Dₜ₂, Tₜ₂); . . . ; P_{tN}(D_{tN}, T_{tN})}.

The training device may use the audio feature extraction training dataset to train the speech translation model 122, use the audio clip Dₜᵢ in the training data pair as a training input, and use the training text Tₜᵢ in the training data pair as a ground truth of the speech translation model 122. The training device may adjust the parameter of the adapter 331 and the parameter of the speech encoder 333 in the speech feature extractor 330 in the speech translation model 122 based on a pre-defined loss function and further with reference to the training output. In some embodiments, a predetermined training termination condition may be set, for example, a certain number of training steps or performance metrics may be set. The training device may stop the training in the first phase when the predetermined training termination condition is met. After the training in the first phase is completed, the trained speech translation model 122 in the first phase may be obtained.

In block 406, the training device may use an alignment training dataset to train, in a second phase, the trained speech translation model 122 in the first phase. The audio feature extractor 330 trained in the second phase may include the trained adapter 331 and the trained speech encoder 333 after the training in the first phase.

In some embodiments, during the training in the second phase, the training device may fix a parameter in the language model 310, and adjust a parameter of the adapter 331 and a parameter of the speech encoder 333 in the audio feature extractor 330. In some embodiments, the training data used by the training device in the second phase includes an alignment training dataset. The alignment training dataset includes a plurality of training data pairs Qₜᵢ (i is a positive integer; 1≤i≤M; M is the number of training data pairs in the alignment training dataset; M may be equal to N), and each training data pair Qₜᵢ includes a training audio clip Dₜᵢ in a source language and a continuation text Cₜᵢ in the source language that corresponds to the training audio clip.

In some embodiments, the training audio clip Dₜᵢ in the alignment training dataset is the training audio clip Dₜᵢ in the audio feature extraction training dataset used in the first phase. The training text Tₜᵢ in the source language that corresponds to each training audio clip Dₜᵢ may be input into the language model 310 in the speech translation model 122, to obtain a continuation text Cₜᵢ in the source language that corresponds to the training audio clip Dₜᵢ. In some embodiments, the continuation text Cₜᵢ may be a text generated by the language model 310 for the training audio clip Dₜᵢ. For example, the language model 310 may receive the training text Tₜᵢ in the source language that corresponds to the training audio clip Dₜᵢ, and continue or expand the text Tₜᵢ based on the content of the text Tₜᵢ, to generate the continuation text Cₜᵢ corresponding to the training audio clip Dₜᵢ. For example, for the training text Tₜ₁ “how are you,” the language model 310 may generate the continuation text Cₜ₁ “I am good” for the training text Tₜ₁. In this way, an aligned training data pair Qₜ₁ (“how are you” in an audio form; “I am good” in a text form) may be obtained. The source language may be English. The alignment training dataset may be represented as {Qₜ₁(Dₜ₁, Cₜ₁); Qₜ₂(Dₜ₂, Cₜ₂); . . . ; Q_{tM}(D_{tM}, C_{tM})}.

The training device may use an alignment training dataset to train, in a second phase, the trained speech translation model 122 in the first phase. The training device may use the training audio clip Dₜᵢ in the aligned training data pair as a training input, and use the continuation text Cₜᵢ in the training data pair as a ground truth of the speech translation model 122. The training device may adjust the parameter of the adapter 331 and the parameter of the speech encoder 333 in the speech translation model 122 based on a pre-defined loss function and further with reference to the training output. In some embodiments, a predetermined training termination condition may be set, for example, a certain number of training steps or performance metrics may be set. The training device may stop the training in the second phase when the predetermined training termination condition is met. After the training in the second phase is completed, the trained speech translation model 330 in the second phase may be obtained.

It may be understood that the training audio clip Dₜᵢ and the continuation text Cₜᵢ in the alignment training dataset used during the training in the second phase are consistent in terms of expression. Through the training in the second phase, audio data may be aligned into a field of an input feature of the language model, so as to help align an output feature of the audio data of the audio feature extractor 330 with the input feature of the language model 310, thereby helping the speech translation model 122 improve the generalization capability.

In block 408, the training device may fine-tune the trained speech translation model 122 in the second phase. In some embodiments, the training device may fix a parameter of the audio feature extractor 330 and fix a parameter of the language model 310. During the fine-tuning, the training device may add a bypass structure to the language model 310. A parameter corresponding to the bypass structure is W₁. The training device may use the newly added parameter W₁ as a parameter to be adjusted for the language model 310. During the fine-tuning, the training device may use the first scaling factor α₁ to scale the parameter W₁ to be adjusted.

During the fine-tuning, the training device may use fine-tuning training data to adjust the scaled parameter to be adjusted. In some embodiments, the fine-tuning training data may include a plurality of training data pairs Rₜᵢ (i is a positive integer; 1≤i≤L; L is the number of training data pairs in the fine-tuning training dataset), and each training data pair includes a fine-tuned audio clip FDₜᵢ in the source language and a training text FTₜᵢ in a sample language that corresponds to the fine-tuned audio clip FDₜᵢ. For example, for the fine-tuned audio clip FDₜᵢ “Hello World!” in the source language of English, when the sample language is Chinese, the training text FTₜᵢ in the sample language (Chinese) corresponding to the fine-tuned audio clip FDₜᵢ is “ [symbol] ”!. In this way, a fine-tuning training data pair Rₜ₁ (“Hello World!” in an audio form; “ [symbol] ” in a text form) may be obtained. The fine-tuning training dataset may be represented as {Rₜ₁(FDₜ₁, FTₜ₁); Rₜ₂(FDₜ₂, FTₜ₂); . . . ; R_{tL}(FD_{tN}, FT_{tM})}.

During the fine-tuning, a pre-trained parameter W₀ in the language model 310 may be fixed, and a bypass structure may be newly added to the language model 310. A parameter corresponding to the bypass structure is W₁, and the newly added parameter W₁ is used as a parameter to be adjusted for the language model 310. The training device uses the first scaling factor α₁ to scale the parameter to be adjusted.

The training device may use the fine-tuning training dataset to fine-tune the speech translation model 122 to adjust the parameter W₁ to be adjusted in the language model 310. In some embodiments, the training device may use the training audio clip FDₜᵢ in the training data pair as a training input, and use the training text FTₜᵢ in the training data pair as a ground truth of the speech translation model 122. The training device may adjust the parameter W₁ to be adjusted in the language model 310 based on a pre-defined loss function and with reference to the training output. In some embodiments, a predetermined training termination condition may be set, for example, a certain number of training steps or performance metrics may be set. The training device may stop the fine-tuning process when the predetermined training termination condition is met. The fine-tuned speech translation model 122 may execute an AST task during inference. For example, the fine-tuned speech translation model 122 may receive an input audio clip and output a translated text corresponding to the audio clip, as described with reference to FIG. 2 and FIG. 3.

By using the method for training a speech translation model according to this embodiment of the present disclosure, a speech translation model having an improved model generalization capability may be obtained. In other words, the trained model has an improved model performance and capability, so that the model can well execute a translation task in an unveiling target language.

A flowchart of a method 500 for training a speech translation model according to an embodiment of the present disclosure is described below with reference to FIG. 5. FIG. 5 is a flowchart of a method 500 for training a speech translation model according to an embodiment of the present disclosure. The method 500 may be performed in the computing device 120 in FIG. 1 or in any proper computing device. For ease of illustration, in the following description, a device performing a training method 500 is referred to as a “training device.” It should be understood that, the method 500 in FIG. 5 may further include additional steps not shown and/or shown steps may be omitted, and the scope of the present disclosure is not limited in this respect.

In some embodiments, the speech translation model may include an audio feature extractor and a language model. The speech translation model has been described in detail above with reference to FIG. 3. Details are not described herein again for the sake of brevity.

In block 502, the training device may adjust a parameter of the audio feature extractor by using an alignment training dataset, to obtain the trained speech translation model. In some embodiments, the alignment training dataset includes a plurality of training data pairs, each training data pair includes a training audio clip in a source language and a continuation text in the source language that corresponds to the training audio clip, and the continuation text is generated by the language model for the training audio clip. This process is similar to the training process in the second phase described in block 406 in FIG. 4, and may be understood with reference to the above-mentioned description. Details are not described herein again for the sake of brevity.

In block 504, the training device may fine-tune the speech translation model by using a first scaling factor, to obtain the fine-tuned speech translation model. In some embodiments, a second scaling factor is used for the fine-tuned speech translation model during inference, and the second scaling factor is less than the first scaling factor.

In some embodiments, the fine-tuning the speech translation model by using a first scaling factor may include scaling a parameter to be adjusted in the language model by using the first scaling factor; and further adjusting the scaled parameter to be adjusted by using a fine-tuning training dataset. In some embodiments, the fine-tuning training data includes a plurality of training data pairs, and each training data pair includes a fine-tuned audio clip in the source language and a training text in a sample language that corresponds to the fine-tuned audio clip. This fine-tuning process is similar to the fine-tuning process described in block 408 in FIG. 4, and may be understood with reference to the above-mentioned description. Details are not described herein again for the sake of brevity.

During the inference, a second scaling factor may be used for the speech translation model 122 to scale the adjusted parameter. Correspondingly, when executing the AST task, the fine-tuned speech translation model 122 translates the received audio feature corresponding to the input audio clip 320 by using the parameter that is scaled by the second scaling factor α₂, so as to obtain the translated text Tₒᵤₜ in the target language. In some embodiments, the adjusted parameter corresponds to the parameter to be adjusted during the fine-tuning. In other words, after the adjustment of the parameter to be adjusted during the fine-tuning, an adjusted parameter in the language model 310 may be obtained. In some embodiments, the second scaling factor is less than the first scaling factor. Further, preferably, the second scaling factor is 0.5 times the first scaling factor.

In some embodiments, the speech translation model may translate an audio clip in the source language into a translated text in a target language during the inference. In some embodiments, the sample language used during the fine-tuning may be different from the target language. For example, the sample language used during the fine-tuning may be French, while the target language during the inference may be Chinese.

In some embodiments, before block 502 in FIG. 5, the training device may further adjust the parameter of the audio feature extractor by using an audio feature extraction training dataset. In some embodiments, the audio feature extraction training dataset includes a plurality of training data pairs, and each training data pair includes a training audio clip in the source language and a training text in the source language that corresponds to the training audio clip. This process is similar to the process described in block 404 in FIG. 4, and may be understood with reference to the above-mentioned description. Details are not described herein again for the sake of brevity.

In some embodiments, before adjusting the parameter of the audio feature extractor by using the audio feature extraction training dataset, the training device may further train a speech encoder in the audio feature extractor in an unsupervised training manner. Reference may be made to the above-mentioned description of the process for block 402 in FIG. 4 for understanding. Details are not described herein again for the sake of brevity.

By using the method for training a speech translation model according to this embodiment of the present disclosure, a speech translation model having an improved model generalization capability may be obtained, and the speech translation task described above may be executed. Moreover, the trained model has an improved model performance and capability, so that the model can well execute a translation task in an unveiling target language.

Table 1 below shows results of BLEURT comparison between a task-specific model and a speech translation model (represented as an “alignment model” in Table 1) according to an embodiment of the present disclosure with respect to translation tasks for translating English into other target languages.

TABLE 1

| | Task-specific model | | Alignment |
|---|---|---|---|
| Task | Single task | Multitasking | model |
| Translate English into Spanish | 69.81 | 69.47 | 70.45 |
| Translate English into Japanese | 27.83 | 31.14 | 55.10 |
| Translate English into | 62.42 | 68.17 | 70.94 |
| Portuguese | | | |
| Translate English into | 60.19 | 71.43 | 74.57 |
| Indonesian | | | |
| Translate English into German | 59.53 | 64.45 | 70.69 |
| Translate English into French | 46.39 | 59.55 | 63.32 |

In Table 1, six translation pairs are compared. For the task-specific model, the sample language used during training of the task-specific model is Spanish. With respect to translating audio in English into a text in Spanish, it may be learned that the task-specific model with a single task outperforms the task-specific model with multitasking. However, with respect to a sample language that is not used during training, the task-specific model with multitasking outperforms the task-specific model with a single task. This means that task overfitting is not very serious in this case.

In addition, the alignment model outperforms the task-specific model in terms of translating English into other sample languages that are not used during training. This indicates that the alignment model effectively utilizes the native translation capabilities of the underlying language model, so that the alignment model has high data efficiency.

Table 2 shows the instruction compliance rate/BLEURT for the single-task model and the alignment model.

TABLE 2

| Task | Single-task AST | Alignment model |
|---|---|---|
| Translate English into Spanish | 100%/69.81 | 100%/70.45 |
| Translate English into Japanese | 44%/27.83 | 100%/55.10 |
| Translate English into Portuguese | 80%/62.42 | 100%/70.94 |
| Translate English into Indonesian | 70%/60.19 | 100%/74.57 |
| Translate English into German | 76%/59.53 | 100%/70.69 |
| Translate English into French | 22%/46.39 | 100%/63.32 |

In Table 2, in the case of translating English into Japanese, the instruction compliance rate of the single-task model is only 44%, whereas the remaining 56% is incorrectly translated into other languages.

In some embodiments, overfitting problems of task-specific training may be resolved in the following two directions: first, the speech translation model according to an embodiment of the present disclosure may be used; second, it may be assumed that most of the task-specific information is learned in the first audio frame. Therefore, during the inference, the first audio frame may be removed for the task-specific model, so that the performance of the task-specific model (e.g., the single-task model) may be improved.

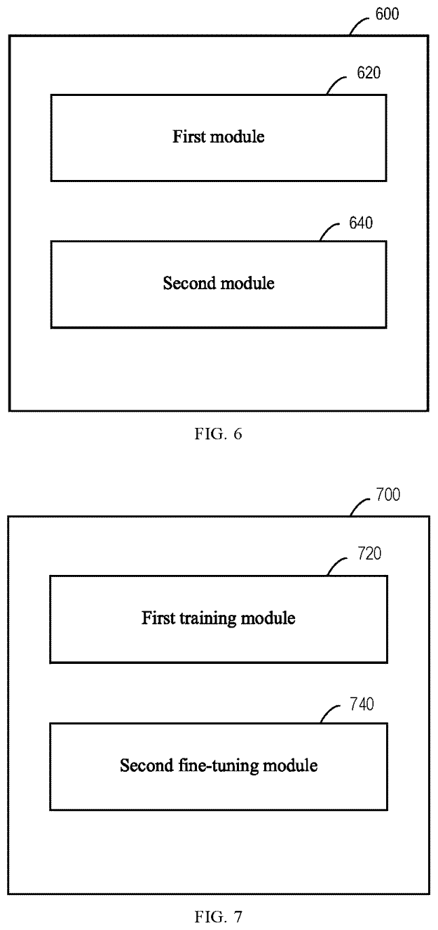

FIG. 6 is a schematic block diagram of an example apparatus 600 according to some embodiments of the present disclosure. The apparatus 600 may be implemented in a form of software, hardware, or a combination of software and hardware. As shown in FIG. 6, the apparatus 600 includes a first module 620 and a second module 640.

In some embodiments, the first module 620 is configured to input an audio clip in a source language into an audio feature extractor in a speech translation model to extract, via the audio feature extractor, a text corresponding to the audio clip. In some embodiments, the second module 640 is configured to input the audio feature into a language model in the speech translation model to obtain, via the language model, a translated text in a target language that corresponds to the audio clip. In some embodiments, a first scaling factor is used for the language model during fine-tuning, a second scaling factor is used for the language model during determination of the translated text, and the second scaling factor is less than the first scaling factor.

The apparatus 600 in FIG. 6 can be used to implement the process described above with reference to FIG. 1 to FIG. 3. For brevity, details are not described herein again.

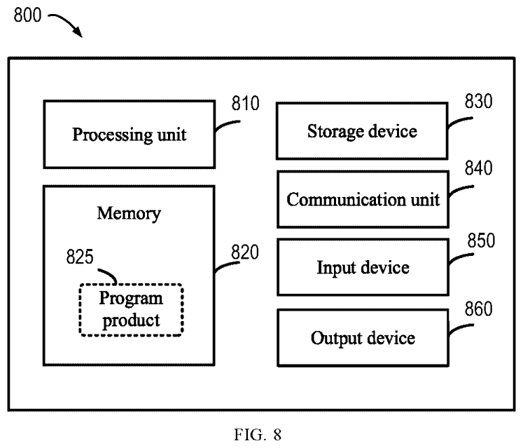

FIG. 7 is a schematic block diagram of an example apparatus 700 according to some embodiments of the present disclosure. The apparatus 700 may be implemented in a form of software, hardware, or a combination of software and hardware. As shown in FIG. 7, the apparatus 700 includes a first training module 720 and a second fine-tuning module 740. The apparatus 700 may be configured to train a speech translation model. The speech translation model may include an audio feature extractor and a language model.

In some embodiments, the first training module 720 is configured to adjust a parameter of the audio feature extractor by using an alignment training dataset, to obtain the trained speech translation model, where the alignment training dataset includes a plurality of training data pairs, each training data pair includes a training audio clip in a source language and a continuation text in the source language that corresponds to the training audio clip, and the continuation text is generated by the language model for the training audio clip. In some embodiments, the second fine-tuning module 740 is configured to fine-tune the speech translation model by using a first scaling factor to obtain a fine-tuned speech translation model, where a second scaling factor is used for the fine-tuned speech translation model during inference, and the second scaling factor is less than the first scaling factor.

The apparatus 700 in FIG. 7 can be configured to implement the training process described above with reference to FIG. 3 to FIG. 5. For brevity, details are not described herein again.

Division of modules or units in the embodiments of the present disclosure is an example and is merely logical function division, and there may be another division manner during actual implementation. In addition, functional units in the embodiments of the present disclosure may be integrated into one unit, each of the units may exist alone physically, or two or more units may be integrated into one unit. The integrated unit may be implemented in the form of hardware, or may be implemented in the form of a software functional unit.

FIG. 8 is a block diagram of an example device 800 that may be used to implement an embodiment of the present disclosure. It should be understood that the device 800 shown in FIG. 8 is merely an example, and should not constitute any limitation on the functions and scopes of the implementations described herein. For example, the example device 800 may correspond to the computing device 120 described herein with reference to FIG. 1, and may be used to perform the processes described above in FIG. 1 to FIG. 7.

As shown in FIG. 8, the device 800 is in a form of a general-purpose computing device. Components of the computing device 800 may include but are not limited to one or more processors or processing units 810, a memory 820, a storage device 830, one or more communication units 840, one or more input devices 850, and one or more output devices 860. The processing unit 810 may be a physical or virtual processor, and may perform various processing based on a program stored in the memory 820. In a multi-processor system, a plurality of processing units execute computer-executable instructions in parallel, to improve a parallel processing capability of the computing device 800.

The computing device 800 generally includes a plurality of computer storage media. Such media may be any available media accessible by the computing device 800, including, but not limited to, volatile and non-volatile media and removable and non-removable media. The memory 820 may be a volatile memory (for example, a register, a cache, or a random-access memory (RAM)), a non-volatile memory (for example, a read only memory (ROM), an electrically erasable programmable read only memory (EEPROM), or a flash memory), or a certain combination thereof. The storage device 830 may be a removable or non-removable medium, may include a machine-readable medium, for example, a flash drive, a disk, or any other medium, and may be configured to store information and/or data (for example, training data for training) and accessed in the computing device 800.

The computing device 800 may further include other removable/non-removable and volatile/non-volatile storage media. Although not shown in FIG. 8, a disk drive for reading from or writing into removable and non-volatile disks (for example, a “floppy disk”) and an optical disc drive for reading from or writing into removable and non-volatile optical discs may be provided. In these cases, each drive may be connected to a bus (not shown) through one or more data medium interfaces. The memory 820 may include a computer program product 825 having one or more program modules that are configured to perform various methods or actions in various implementations of the present disclosure.

The communication unit 840 implements communication with another computing device through a communication medium. In addition, functions of the components of the computing device 800 may be implemented by a single computing cluster or a plurality of computing machines, and these computing machines can communicate through a communication connection. Therefore, the computing device 800 may perform operations in a networked environment through a logical connection to one or more other servers, a network personal computer (PC), or another network node.

The input device 850 may be one or more input devices, such as a mouse, a keyboard, and a trackball. The output device 860 may be one or more output devices, such as a display, a speaker, and a printer. The computing device 800 may further communicate, through the communication unit 840 as required, with one or more external devices (not shown), for example, a storage device and a display device, with one or more devices enabling a user to interact with the computing device 800, or with any device (for example, a network interface card or a modem) enabling the computing device 800 to communicate with one or more other computing devices. Such communication may be performed through an input/output (I/O) interface (not shown).

According to an example implementation of the present disclosure, a computer-readable storage medium having computer-executable instructions stored thereon is provided. The computer-executable instructions are executed by a processor to implement the method described above. According to an example implementation of the present disclosure, there is further provided a computer program product. The computer program product is tangibly stored on a non-transitory computer-readable medium, and includes computer-executable instructions. The computer-executable instructions are executed by a processor to implement the method described above. According to an example implementation of the present disclosure, a computer program product having a computer program stored thereon is provided. The program, when executed by a processor, causes the method described above to be implemented.

Various aspects of the present disclosure are described here with reference to the flowcharts and/or the block diagrams of the method, the apparatus, the device, and the computer program product implemented according to the present disclosure. It should be understood that each block of the flowchart and/or the block diagrams and a combination of blocks in the flowchart and/or the block diagrams may be implemented by computer-readable program instructions.

These computer-readable program instructions may be provided to a processing unit of a general-purpose computer, a special-purpose computer, or another programmable data processing apparatus to produce a machine, such that the instructions, when executed by the processing unit of the computer or another programmable data processing apparatus, create an apparatus for implementing functions/actions specified in one or more blocks in the flowcharts and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

The computer-readable program instructions may be loaded onto a computer, another programmable data processing apparatus, or another device, such that a series of operation steps are performed on the computer, another programmable data processing apparatus, or another device to produce a computer-implemented process. Therefore, the instructions executed on the computer, another programmable data processing apparatus, or another device implement functions/actions specified in one or more blocks in the flowcharts and/or the block diagrams.

The flowcharts and the block diagrams in the accompanying drawings illustrate possible system architectures, functions, and operations of the system, the method, and the computer program product according to a plurality of implementations of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions marked in the blocks may occur in a sequence different from that marked in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various implementations of the present disclosure are described above. The above-mentioned descriptions are examples, not exhaustive, and are not limited to the disclosed implementations. Many modifications and variations are apparent to a person of ordinary skill in the art without departing from the scope and spirit of the described implementations. Selection of terms used in this specification is intended to best explain principles of the implementations, actual application, or improvements to technologies in the market, or to enable another person of ordinary skill in the art to understand the implementations disclosed in this specification.

I/We claim:

1. A speech translation method, comprising:
inputting an audio clip in a source language into an audio feature extractor in a speech translation model to extract, via the audio feature extractor, an audio feature corresponding to the audio clip; and
inputting the audio feature into a language model in the speech translation model to obtain, via the language model, a translated text in a target language that corresponds to the audio clip,
wherein a first scaling factor is used for the language model during fine-tuning, a second scaling factor is used for the language model during determination of the translated text, and the second scaling factor is less than the first scaling factor.

2. The method according to claim 1, wherein the second scaling factor is 0.5 times the first scaling factor.

3. The method according to claim 1, wherein using the first scaling factor comprises: scaling a parameter to be adjusted of the language model by using the first scaling factor during the fine-tuning; wherein using the second scaling factor comprises: scaling a part of parameters in the language model by using the second scaling factor during determination of the translated text, wherein the fine-tuned parameter to be adjusted corresponds to the part of parameters.

4. The method according to claim 1, further comprising:
obtaining an instruction text corresponding to a received instruction; and
inputting the instruction text into the language model, wherein the language model determines the target language based on the instruction text.

5. The method according to claim 1, further comprising:
processing, via a speech recognition model, an audio input comprising the audio clip, to obtain an output text in the source language that corresponds to the audio input,
wherein the output text comprises context information of the audio clip, and the context information comprises a current sentence corresponding to the audio clip, and previous and subsequent sentences adjacent to the current sentence.

6. The method according to claim 1, wherein the speech translation model is trained in a first phase in the following manner:
adjusting a parameter of the audio feature extractor by using an audio feature extraction training dataset, to obtain the trained speech translation model in the first phase,
wherein the audio feature extraction training dataset comprises a plurality of training data pairs, and each training data pair comprises a training audio clip in the source language and a training text in the source language that corresponds to the training audio clip.

7. The method according to claim 6, wherein the speech translation model is trained in a second phase in the following manner:
adjusting the parameter of the audio feature extractor in the trained speech translation model in the first phase by using an alignment training dataset, to obtain the trained speech translation model in the second phase,
wherein the alignment training dataset comprises a plurality of training data pairs, each training data pair comprises the training audio clip and a continuation text in the source language that corresponds to the training audio clip, and the continuation text is generated by the language model for the training audio clip.

8. The method according to claim 7, wherein after the second phase, the speech translation model is fine-tuned in the following manner:
scaling a parameter to be adjusted in the language model by using the first scaling factor; and
adjusting the scaled parameter to be adjusted by using a fine-tuning training dataset,
wherein the fine-tuning training dataset comprises a plurality of training data pairs, and each training data pair comprises a fine-tuned audio clip in the source language and a training text in a sample language that corresponds to the fine-tuned audio clip.

9. The method according to claim 8, wherein during the fine-tuning, the parameter of the audio feature extractor remains unchanged, and the parameter to be adjusted is a parameter newly added to the language model during the fine-tuning.

10. The method according to claim 8, wherein the sample language is different from the target language.

11. The method according to claim 6, wherein the audio feature extractor comprises a speech encoder, and before the first phase, the speech encoder is trained in an unsupervised manner.

12. A method for training a speech translation model, wherein the speech translation model comprises an audio feature extractor and a language model, and the method comprises:
adjusting a parameter of the audio feature extractor by using an alignment training dataset, to obtain the trained speech translation model, wherein the alignment training dataset comprises a plurality of training data pairs, each training data pair comprises a training audio clip in a source language and a continuation text in the source language that corresponds to the training audio clip, and the continuation text is generated by the language model for the training audio clip; and
fine-tuning the speech translation model by using a first scaling factor to obtain a fine-tuned speech translation model, wherein a second scaling factor is used for the fine-tuned speech translation model during inference, and the second scaling factor is less than the first scaling factor.

13. The method according to claim 12, wherein before adjusting a parameter of the audio feature extractor by using an alignment training dataset, to obtain the trained speech translation model, the method further comprises:
adjusting the parameter of the audio feature extractor by using an audio feature extraction training dataset,
wherein the audio feature extraction training dataset comprises a plurality of training data pairs, and each training data pair comprises the training audio clip in the source language and a training text in the source language that corresponds to the training audio clip.

14. The method according to claim 13, wherein before adjusting the parameter of the audio feature extractor by using an audio feature extraction training dataset, the method further comprises:
training a speech encoder in the audio feature extractor in an unsupervised training manner.

15. The method according to claim 12, wherein fine-tuning the speech translation model by using a first scaling factor comprises:
scaling a parameter to be adjusted in the language model by using the first scaling factor; and
adjusting the scaled parameter to be adjusted by using a fine-tuning training dataset,
wherein the fine-tuning training dataset comprises a plurality of training data pairs, and each training data pair comprises a fine-tuned audio clip in the source language and a training text in a sample language that corresponds to the fine-tuned audio clip.

16. The method according to claim 15, wherein fine-tuning the speech translation model by using a first scaling factor further comprises:
keeping the parameter of the audio feature extractor unchanged, wherein the parameter to be adjusted is a parameter newly added to the language model during the fine-tuning.

17. The method according to claim 15, wherein the speech translation model translates an audio clip in the source language into a translated text in a target language during the inference.

18. The method according to claim 17, wherein the sample language is different from the target language.

19. An electronic device, comprising:
at least one processing unit; and
at least one memory, wherein the at least one memory is coupled to the at least one processing unit, and stores instructions executable by the at least one processing unit, and the instructions, when executed by the at least one processing unit, cause the electronic device to:
input an audio clip in a source language into an audio feature extractor in a speech translation model to extract, via the audio feature extractor, an audio feature corresponding to the audio clip; and
input the audio feature into a language model in the speech translation model to obtain, via the language model, a translated text in a target language that corresponds to the audio clip,
wherein a first scaling factor is used for the language model during fine-tuning, a second scaling factor is used for the language model during determination of the translated text, and the second scaling factor is less than the first scaling factor.

20. The electronic device according to claim 19, wherein using the first scaling factor comprises: scaling a parameter to be adjusted of the language model by using the first scaling factor during the fine-tuning; wherein using the second scaling factor comprises: scaling a part of parameters in the language model by using the second scaling factor during determination of the translated text, wherein the fine-tuned parameter to be adjusted corresponds to the part of parameters.
